(19) United States
(12) Patent Application Publication
(10) Pub. No.: US 2023/0072625 A1
(43) Pub. Date: Mar. 9, 2023

(54) SYSTEMS AND METHODS FOR ONLINE TO OFFLINE SERVICES

(71) Applicant: BEIJING DIDI INFINITY TECHNOLOGY AND DEVELOPMENT CO., LTD., Beijing (CN)

(72) Inventor: Cheng ZHANG, Beijing (CN)

(73) Assignee: BEIJING DIDI INFINITY TECHNOLOGY AND DEVELOPMENT CO., LTD., Beijing (CN)

(21) Appl. No.: 18/055,820

(22) Filed: Nov. 15, 2022

Related U.S. Application Data
(63) Continuation of application No. PCT/CN2020/090895, filed on May 18, 2020.

(51) Int. Cl. G06Q 10/06

(52) U.S. Cl. CPC G06Q 10/06311

(57) ABSTRACT

Systems and methods for online to offline services are provided. The methods may include obtaining a first service request issued by a first service requester, the first service request including a request time point, a start location, and a destination. The methods may further include determining a target time point based on at least one of the request time point or an input by the first service requester, wherein the target time point is after the request time point. The methods may further include obtaining one or more candidate service requests, and determining a service request set and a target service provider that matches with the service request set by executing, starting at the target time point, a matching process based on the first service request and the one or more candidate service requests. The service request set may include the first service request.

### CROSS-REFERENCE TO RELATED APPLICATIONS

This application is a Continuation of International Application No. PCT/CN2020/090895, filed on May 18, 2020, the contents of which are hereby incorporated by reference.

### TECHNICAL FIELD

The present disclosure generally relates to online to offline services, and in particular, to systems and methods for determining a service request set and a target service provider. The service request set may include one or more service requests for one or more sharable services.

### BACKGROUND

Online to offline services utilizing Internet technology have become increasingly popular. For example, the online to offline services may include a car-hailing service, a chauffeur service, a delivery service, a bus service, or the like, or a combination thereof. In some cases, a service request for a sharable service (e.g., a carpooling service) may be combined with one or more other service requests for one or more sharable services to reduce the usage of resources. A target service provider may provide multiple services corresponding to the service requests for sharable services. After a first service request is issued, a matching process is often executed in real time. The matching process may be configured to determine whether there are one or more second service requests matched with the first service request and for determining a target service provider that matches with the first service request and the one or more second service requests. In some cases, there can be only a few candidate service requests and candidate service providers when the matching process is executed in real time. As a result, it may be difficult to find the one or more second service requests matched with the first service request and the target service provider. Thus, it is desirable to provide systems and methods for determining a target time point for more efficiently executing the matching process associated with the online to offline services.

### SUMMARY

According to an aspect of the present disclosure, a system for online to offline services is provided. The system may include at least one storage device storing a set of instructions, and at least one processor in communication with the storage device. When executing the set of instructions, the at least one processor may be directed to cause the system to obtain a first service request issued by a first service requester. The first service request may include a request time point, a start location, and a destination. The at least one processor may be further directed to cause the system to determine a target time point based on at least one of the request time point or an input by the first service request. The target time point may be after the request time point. The at least one processor may be further directed to cause the system to obtain one or more candidate service requests and determine a service request set and a target service provider that matches with the service request set by executing, starting at the target time point, a matching process based on the first service request and the one or more candidate service requests. The service request set includes the first service request.

In some embodiments, to determine the target time point based on the at least one of the request time point or the input by the first service requester, the at least one processor may be directed to cause the system to obtain a first input by the first service provider and determine the target time point based on the first input. The first input may indicate that the first service provider agrees with a delay of executing the matching process based on the first service request and the one or more candidate service requests.

In some embodiments, to determine the target time point based on the at least one of the request time point or the input by the first service requester, the at least one processor may be directed to cause the system to obtain first reference information and estimate, based on the first reference information, a probability that the first service provider agrees with a delay of executing the matching process. The at least one processor may be further directed to cause the system to compare the probability with a probability threshold and determine the target time point based on a result of the comparison.

In some embodiments, to determine the target time point based on the at least one of the request time point or the input by the first service requester, the at least one processor may be directed to cause the system to obtain second reference information and estimate, based on the second reference information, a waiting time period that the first service requester is willing to wait from the request time point to the target time point. The at least one processor may be further directed to cause the system to determine the target time point based on the waiting time period and the request time point.

In some embodiments, the second reference information may include at least one of the start location, a weather condition, a traffic condition, preference information of the first service requester, one or more historical service requests of the first service requester, or one or more historical service requests of other service requesters.

In some embodiments, the one or more candidate service requests may be obtained between the request time point and the target time point.

In some embodiments, the target time point may be determined from a set of predetermined time points.

In some embodiments, the at least one processor may be directed to cause the system to generate a message configured to notify the first service requester of a processing progress associated with the first service request. The processing progress may include a processing status of the first service request at the target time point.

In some embodiments, the one or more candidate service requests include at least one of one or more first candidate service requests to be allocated or one or more second candidate service requests. The one or more second candidate service requests may have been accepted by one or more candidate service providers but may have not been completed.

In some embodiments, the service request set may further include one or more second service requests issued by one or more second service requesters. The one or more second service requests may be matched with the first service requests. The one or more second service requests may be determined from the one or more candidate service requests.

In some embodiments, the target service provider may be selected from one or more candidate service providers including at least one of one or more first candidate service providers or one or more second candidate service providers. The one or more first candidate service providers may have accepted at least one of the one or more second service requests and may have not completed the at least one of the one or more second service requests. The one or more second candidate service providers are not providing any service.

In some embodiments, to select the target service provider from the one or more candidate service providers, the at least one processor may be directed to cause the system to obtain first feature information of each of the one or more candidate service providers and second feature information associated with the service request set. The at least one processor may be further directed to cause the system to, for each of the one or more candidate service providers, determine a matching degree between the candidate service provider and the service request set based on the first feature information and the second feature information. The at least one processor may be further directed to cause the system to determine, based on the one or more matching degrees, the target service provider from the one or more candidate service providers.

According to another aspect of the present disclosure, a method for online to offline services is provided. The method may be implemented on a computing device having at least one processor and at least one non-transitory storage medium. The method may include obtaining a first service request issued by a first service requester, the first service request including a request time point, a start location, and a destination. The method may further include determining a target time point based on at least one of the request time point or an input by the first service requester, wherein the target time point is after the request time point. The method may further include obtaining one or more candidate service requests, and determining a service request set and a target service provider that matches with the service request set by executing, starting at the target time point, a matching process based on the first service request and the one or more candidate service requests. The service request set may include the first service request.

According to yet another aspect of the present disclosure, a system for online to offline services is provided. The system may include an obtaining module, configured to obtain a first service request issued by a first service requester and obtain one or more candidate service requests. The first service request may include a request time point, a start location, and a destination. The system may further include a target time point determination module, configured to determine a target time point based on at least one of the request time point or an input by the first service requester. The target time point may be after the request time point. The system may further include a matching module, configured to determine a service request set and a target service provider that matches with the service request set by executing, starting at the target time point, a matching process based on the first service request and the one or more candidate service requests. The service request set may include the first service request.

According to yet another aspect of the present disclosure, a non-transitory computer readable medium, comprising a set of instructions for online to offline services. When executed by at least one processor, the set of instructions may direct the at least one processor to effectuate a method. The method may include obtaining a first service request issued by a first service requester, the first service request may include a request time point, a start location, and a destination. The method may further include determining a target time point based on at least one of the request time point or an input by the first service requester. The target time point may be after the request time point. The method may further include obtaining one or more candidate service requests. The method may further include determining a service request set and a target service provider that matches with the service request set by executing, starting at the target time point, a matching process based on the first service request and the one or more candidate service requests. The service request set may include the first service request.

According to still another aspect of the present disclosure, a system for online to offline services is provided. The system may include at least one storage device storing a set of instructions and at least one processor in communication with the storage device. When executing the set of instructions, the at least one processor may be directed to cause the system to receive a first service request issued by a first service requester. The first service request may include a request time point, a start location, and a destination. The at least one processor may be further directed to cause the system to transmit the first service request to a server and receive a processing progress associated with the first service request. The processing progress may include a processing status of the first service request at a target time point and present the processing progress to the first service requester via a user interface. The target time point may be determined based on at least one of the request time point or an input by the first service requester. The target time point may be after the request time point.

In some embodiments, the processing status of the first service request at a target time point includes executing a matching process based on the first service request and the one or more candidate service requests, or determining the target service provider.

In some embodiments, the at least one processor may be further directed to cause the system to provide a first option and a second option to the first service requester via the user interface. The first option may indicate that the first service requester agrees with a delay of executing the matching process based on the first service request and the one or more candidate service request, and the second option may indicate that the first service provider agrees with executing, in real time, the matching process. The at least one processor may be further directed to cause the system to receive a first input associated with the first option or a second input associated with the second option from the first service requester.

In some embodiments, the first option may include a set of predetermined time points, and the first input may include selecting a predetermined time point from the set of predetermined time points as the target time point.

In some embodiments, the at least one processor may be further directed to cause the system to transmit the first input or the second input to the server.

In some embodiments, the target time point may be determined based on a waiting time period of the first service requester and the request time point. The waiting time period may be a time period that the first service requester is willing to wait from the request time point to the target time point. The waiting time period may be estimated based on reference information.

In some embodiments, the reference information may include at least one of the start location, a weather condition, a traffic condition, preference information of the first service requester, one or more historical service requests of the first service requester, or one or more historical service requests of other service requesters.

In some embodiments, the target time point may be determined from a set of predetermined time points.

According to yet another aspect of the present disclosure, a method for online to offline services is provided. The method may be implemented on a computing device having at least one processor and at least one non-transitory storage medium. The method may include receiving a first service request issued by a first service requester. The first service request may include a request time point, a start location, and a destination. The method may further include transmitting the first service request to a server and receiving a processing progress associated with the first service request. The processing progress may include a processing status of the first service request at a target time point. The method may further include presenting the processing progress to the first service requester via a user interface. The target time point is determined based on at least one of the request time point or an input by the first service requester, and wherein the target time point may be after the request time point.

According to still another aspect of the present disclosure, a system for online to offline services is provided. The system may include a receiving module, configured to receive a first service request issued by a first service requester and receive a processing progress associated with the first service request. The first service request may include a request time point, a start location, and a destination. The processing progress may include a processing status of the first service request at a target time point. The system may further include a transmitting module, configured to transmit the first service request to a server. The system may further include a presenting module, configured to present the processing progress to the first service requester via a user interface. The target time point may be determined based on at least one of the request time point or an input by the first service requester. The target time point may be after the request time point.

According to yet another aspect of the present disclosure, a non-transitory computer readable medium, comprising a set of instructions for online to offline services, wherein when executed by at least one processor, the set of instructions may direct the at least one processor to effectuate a method. The method may include receiving a first service request issued by a first service requester. The first service request may include a request time point, a start location, and a destination. The method may further include transmitting the first service request to a server and receiving a processing progress associated with the first service request. The processing progress may include a processing status of the first service request at a target time point. The method may further include presenting the processing progress to the first service requester via a user interface. The target time point may be determined based on at least one of the request time point or an input by the first service requester. The target time point may be after the request time point.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary system for online to offline services according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating an exemplary terminal device according to some embodiments of the present disclosure;

FIG. 4 is a block diagram illustrating an exemplary device for online to offline services according to some embodiments of the present disclosure;

FIG. 5 is a block diagram illustrating an exemplary device for online to offline services according to some embodiments of the present disclosure;

FIG. 6 is a flowchart illustrating an exemplary process for online to offline services according to some embodiments of the present disclosure;

FIG. 7 is a flowchart illustrating an exemplary process for determining a target time point based on an input by the first service requester according to some embodiments of the present disclosure;

FIG. 8 is a flowchart illustrating an exemplary process for determining a target time point based on first reference information according to some embodiments of the present disclosure;

FIG. 9 is a flowchart illustrating an exemplary process for determining a target time point based on second reference information according to some embodiments of the present disclosure;

FIG. 10 is a flowchart illustrating an exemplary process for online to offline services according to some embodiments of the present disclosure; and

FIGS. 11A-11D are schematic diagrams illustrating exemplary user interfaces for online to offline services according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding speech recognition in transportation services, it should also be understood that this is only one exemplary embodiment. The system or method of the present disclosure may be applied to user of any other kind of scenarios that requires speech information to be recognized. For example, the system or method of the present disclosure may be applied to an E-business service, an online shopping service, a voice controlling system, or the like, or any combination thereof. The application scenarios of the system or method of the present disclosure may include a webpage, a plug-in of a browser, a client terminal, a custom system, an internal analysis system, an artificial intelligence robot, or the like, or any combination thereof.

The terms “passenger,” “requester,” “requestor,” “service requester,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure refers to an individual, an entity or a tool that may request a service, order a service, provide a service, or facilitate the providing of the service. In the present disclosure, terms “requester” and “requester terminal” may be used interchangeably, and terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or a combination thereof. The service request may be accepted by any one of a passenger, a requester, a service requester, a customer, a driver, a provider, a service provider, or a supplier. The service request may be chargeable or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a Beidou navigation satellite system, a wireless fidelity (WiFi) positioning technology, or the like, or any combination thereof. One or more of the above positioning technologies may be used interchangeably in the present disclosure. For example, the GPS-based method and the WiFi-based method may be used together as positioning technologies to locate the wireless device.

An aspect of the present disclosure relates to systems and/or methods for online to offline services. The online to offline services may include sharable services, such as carpooling services. The methods may include obtaining a first service request issued by a first service requester. The first service request may include a request time point, a start location, and a destination. The methods may further include determining a target time point based on the request time point and/or an input by the first service requester. A matching process for determining a service request set and a target service provider may be executed, starting at the target time point. For example, the first service requester may decide to delay executing the matching process and give a first input via a user interface implemented on the terminal device. Alternatively, the first service requester may decide to execute the matching process in real time and give a second input via the user interface. As another example, whether to execute the matching process in real time or to delay executing the matching process may be determined based on the request time point and first reference information. In some embodiments, the target time point may be determined based on a waiting time period and the request time point. In some embodiments, the target time point may be determined from a set of predetermined time points. When one or more second service requests are matched with the first service request, the service request set may include the first service request and the one or more second service requests. The target service provider may provide one or more services for the service request set.

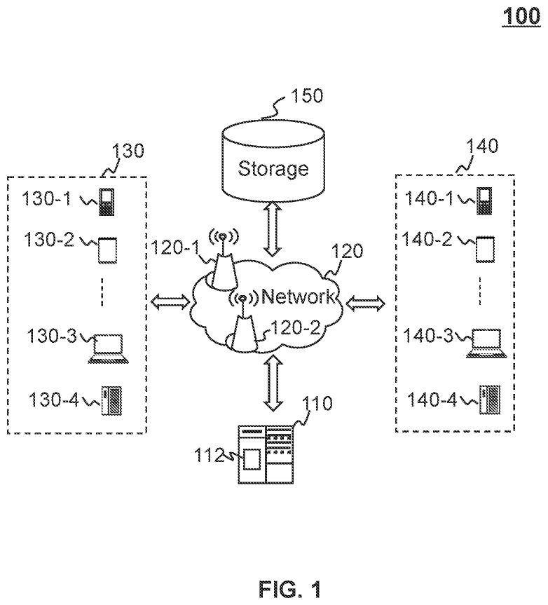

FIG. 1 is a schematic diagram illustrating an exemplary system for online to offline services according to some embodiments of the present disclosure. For example, the online to offline services may include transportation services such as taxi-hailing services, chauffeur services, delivery services, express car services, carpooling services, bus services, shuttle services, or the like, or a combination thereof. The system 100 may include a server 110, a network 120, a requester terminal 130, a provider terminal 140, and a storage 150.

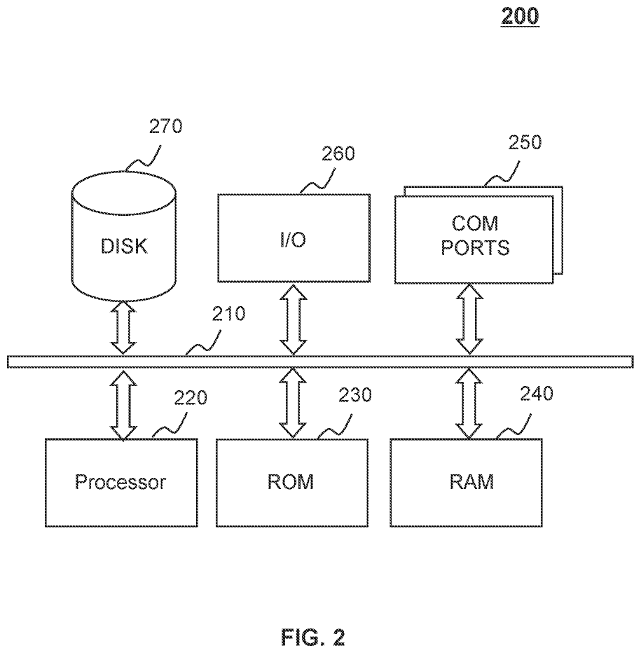

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage 150 via the network 120. As another example, the server 110 may be directly connected to the requester terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or a combination thereof. In some embodiments, the server 110 may be implemented on a computing device 200 having one or more components illustrated in FIG. 2.

In some embodiments, the server 110 may include a processing engine 112. The processing engine 112 may process information and/or data relating to a service request to perform one or more functions described in the present disclosure. For example, the processing engine 112 may obtain a first service request issued by a first service requester. The first service request may include a request time point, a start location, and a destination. As another example, the processing engine 112 may determine a target time point based on the request time point and/or an input by the first service requester. As yet another example, the processing engine 112 may execute a matching process, starting at the target time point, for determining a service request set and a target service provider. When one or more second service requests are matched with the first service request, the service request set may include the first service request and the one or more second service requests. The target service provider may provide one or more services for the service request set. In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or a combination thereof.

The network 120 may facilitate exchange of information and/or data. In some embodiments, one or more components of the system 100 (e.g., the server 110, the requester terminal 130, the provider terminal 140, and/or the storage 150) may transmit information and/or data to another component(s) of the system 100 via the network 120. For example, the server 110 may obtain a service request from the requester terminal 130 via the network 120. In some embodiments, the network 120 may be any type of wired or wireless network, or a combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or a combination thereof. In some embodiments, the network 120 may include one or more network access points. For example, the network 120 may include wired or wireless network access points such as base stations and/or internet exchange points 120-1, 120-2, . . . , through which one or more components of the system 100 may be connected to the network 120 to exchange data and/or information.

In some embodiments, a service requester may be a user of the requester terminal 130. In some embodiments, the user of the requester terminal 130 may be someone other than the service requester. For example, a user A of the requester terminal 130 may use the requester terminal 130 to send a service request for a user B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110. In some embodiments, the request terminal 130 may present a first option and a second option to the first service requester via the user interface before or after the first service requester issues the first service request. The first option may indicate that the first service requester agrees with a delay of executing the matching process. The first input by the first service requester may include selecting the first option. Additionally or alternatively, the first option may include a set pf predetermined time points. The request terminal 130 may receive a first input by the first service requester that includes selecting a predetermined time point from the set of predetermined time points as the target time point. The second option may indicate that the first service requester agrees with executing, in real time, the matching process. The request terminal 130 may receive a second input by the first service requester that includes selecting the second option. In some embodiments, the user terminal 130 may perform one or more functions of the processing engine 112 described earlier. For example, the user terminal 130 may determine a target time point based on the first input or the second input by the first.

In some embodiments, the requester terminal 130 may include a mobile device 130-1, a tablet computer 130-2, a laptop computer 130-3, a built-in device in a vehicle 130-4, or the like, or a combination thereof. In some embodiments, the mobile device 130-1 may include a smart home device, a wearable device, a smart mobile device, a virtual reality device, an augmented reality device, or the like, or a combination thereof. In some embodiments, the smart home device may include a smart lighting device, a control device of an intelligent electrical apparatus, a smart monitoring device, a smart television, a smart video camera, an interphone, or the like, or a combination thereof. In some embodiments, the wearable device may include a smart bracelet, a smart footgear, a smart glass, a smart helmet, a smart watch, a smart clothing, a smart backpack, a smart accessory, or the like, or a combination thereof. In some embodiments, the smart mobile device may include a smartphone, a personal digital assistant (PDA), a gaming device, a navigation device, a point of sale (POS) device, or the like, or a combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or a combination thereof. For example, the virtual reality device and/or the augmented reality device may include a Google Glass™, an Oculus Rift™, a Hololens™, a Gear VR™, etc. In some embodiments, a built-in device in the vehicle 130-4 may include an onboard computer, an onboard television, etc. In some embodiments, the requester terminal 130 may be a device with positioning technology for locating the location of the service requester and/or the requester terminal 130.

In some embodiments, the provider terminal 140 may be similar to, or the same device as the requester terminal 130. In some embodiments, the provider terminal 140 may be a device with positioning technology for locating the location of the service provider and/or the provider terminal 140. In some embodiments, the requester terminal 130 and/or the provider terminal 140 may communicate with another positioning device to determine the location of the service requester, the requester terminal 130, the service provider, and/or the provider terminal 140. In some embodiments, the requester terminal 130 and/or the provider terminal 140 may send positioning information to the server 110.

The storage 150 may store data and/or instructions relating to a service request. In some embodiments, the storage 150 may store data obtained from the requester terminal 130 and/or the provider terminal 140. For example, the storage 150 may store a service request obtained from the requester terminal 130. As another example, the storage 150 may store a machine learning model for determining the target time point. In some embodiments, the storage 150 may store data and/or instructions that the server 110 may execute or use to perform exemplary methods described in the present disclosure. For example, the storage 150 may store data and/or instructions for assigning a service request to a service provider. In some embodiments, the storage 150 may store location information associated with the requester terminal 130 and/or the provider terminal 140. In some embodiments, the storage 150 may include a mass storage, removable storage, a volatile read-and-write memory, a read-only memory (ROM), or the like, or a combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or a combination thereof.

In some embodiments, the storage 150 may be connected to the network 120 to communicate with one or more components of the system 100 (e.g., the server 110, the requester terminal 130, and/or the provider terminal 140). One or more components of the system 100 may access the data and/or instructions stored in the storage 150 via the network 120. In some embodiments, the storage 150 may be directly connected to or communicate with one or more components of the system 100 (e.g., the server 110, the requester terminal 130, and/or the provider terminal 140). In some embodiments, the storage 150 may be part of the server 110.

In some embodiments, one or more components of the system 100 (e.g., the server 110, the requester terminal 130, the provider terminal 140) may have permissions to access the storage 150. In some embodiments, one or more components of the system 100 may read and/or modify information relating to the service requester, the service provider, and/or the public when one or more conditions are met. For example, the server 110 may read and/or modify one or more service requesters' information after the service is completed. As another example, the provider terminal 140 may access information relating to the service requester when receiving a service request from the requester terminal 130, but the provider terminal 140 may not modify the relevant information of the service requester.

In some embodiments, information exchanging of one or more components of the system 100 may be achieved by way of requesting a service. The object of the service may be any product. In some embodiments, the product may be a tangible product or an immaterial product. The tangible product may include food, medicine, commodity, chemical product, electrical appliance, clothing, car, housing, luxury, or the like, or a combination thereof. The immaterial product may include a servicing product, a financial product, a knowledge product, an internet product, or the like, or a combination thereof. The internet product may include an individual host product, a web product, a mobile internet product, a commercial host product, an embedded product, or the like, or a combination thereof. The mobile internet product may be used in software of a mobile terminal, a program, a system, or the like, or a combination thereof. The mobile terminal may include a tablet computer, a laptop computer, a mobile phone, a personal digital assistant (PDA), a smartwatch, a point of sale (POS) device, an onboard computer, an onboard television, a wearable device, or the like, or a combination thereof. For example, the product may be any software and/or application used in the computer or mobile phone. The software and/or application may relate to socializing, shopping, transporting, entertainment, learning, investment, or the like, or a combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or a combination thereof.

One of ordinary skill in the art would understand that when an element of the system 100 performs, the element may perform through electrical signals and/or electromagnetic signals. For example, when the server 110 processes a task, such as obtaining a service request via the network 120, the server 110 may operate logic circuits in its processor to process such task. The server 110 may communicate with the system 100 via a wired network, the at least one information exchange port may be physically connected to a cable, which may further transmit the electrical signals to an input port (e.g., an information exchange port) of the requester terminal 130. If the server 110 communicates with the system 100 via a wireless network, the at least one information exchange port may be one or more antennas, which may convert the electrical signals to electromagnetic signals. Within an electronic device, such as the requester terminal 130, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), the processor may send out electrical signals to a read/write device of the storage medium, which may read or write structured data in the storage medium. The structured data may be transmitted to the processor in the form of electrical signals via a bus of the electronic device. Here, an electrical signal refers to one electrical signal, a series of electrical signals, and/or a plurality of discrete electrical signals.

FIG. 2 is a schematic diagram illustrating exemplary hardware and/or software components of a computing device according to some embodiments of the present disclosure. In some embodiments, the server 110 and/or the user terminal 130 may be implemented on the computing device 200 shown in FIG. 2. For example, the processing engine 112 may be implemented on the computing device 200 and configured to perform functions of the processing engine 112 disclosed in this disclosure.

The computing device 200 may be used to implement any component of the system 100 as described herein. For example, the processing engine 112 may be implemented on the computing device 200, via its hardware, software program, firmware, or a combination thereof. Although only one such computer is shown, for convenience, the computer functions relating to the online to offline services as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may further include program storage and data storage of different forms including, for example, a disk 270, and a read-only memory (ROM) 230, or a random-access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 may also include an I/O component 260, supporting input/output between the computer and other components. The computing device 200 may also receive programming and data via network communications.

Merely for illustration, only one processor is illustrated in FIG. 2. Multiple processors 220 are also contemplated; thus, operations and/or method steps performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors 220 jointly or separately in the computing device 200 (e.g., a first processor executes step A and a second processor executes step B or the first and second processors jointly execute steps A and B).

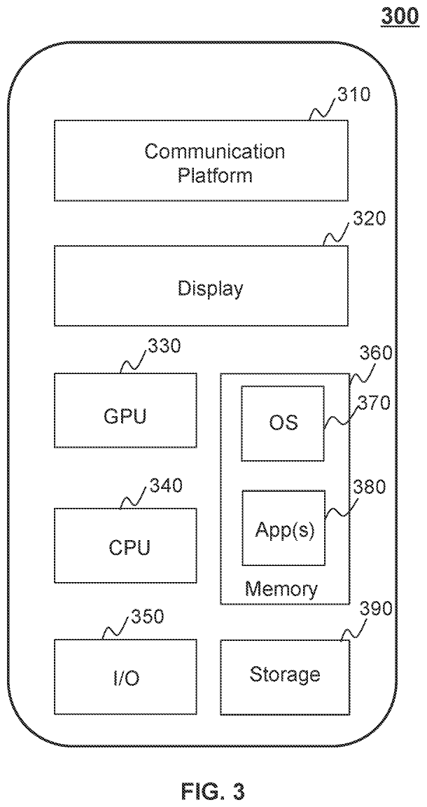

FIG. 3 is a schematic diagram illustrating exemplary hardware and/or software components of a terminal device according to some embodiments of the present disclosure. In some embodiments, the user terminal 130 may be implemented on the terminal device 300 shown in FIG. 3. The terminal device 300 may be a mobile device, such as a mobile phone of a passenger or a driver, a built-in device on a vehicle driven by the driver. As illustrated in FIG. 3, the terminal device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the terminal device 300.

In some embodiments, an operating system 370 (e.g., iOS™, Android™′ Windows Phone™, etc.) and one or more Apps (applications) 380 may be loaded into the memory 360 from the storage 390 in order to be executed by the CPU 340. In some embodiments, the terminal device 300 may include a microphone for acquiring speech information from a service requester. In some embodiments, a application for online to offline services may be installed on the terminal device. For instance, the application for online to offline services may include a car-hailing application, a food delivery application, a carpooling application, etc. In some embodiments, the user may issue a service request via the terminal device 300. User interactions may be achieved via the I/O 350 and provided to the server 110 and/or other components of the system 100 via the network 120. The terminal device 300 may transmit/receive data related to the service request via the communication platform 310. For example, the terminal device 300 may transmit the service request to the server 110 and receive information related to a service provider that matches with the service request.

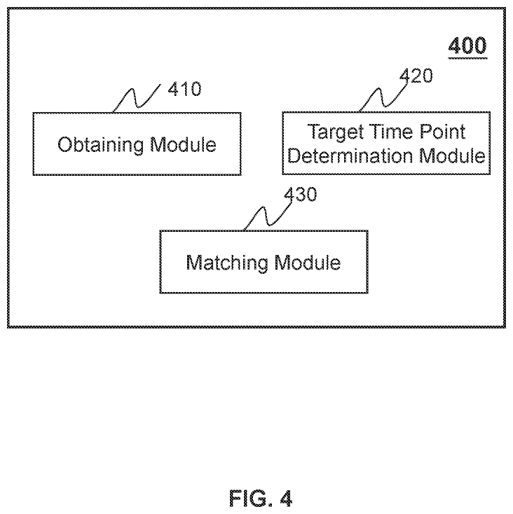

FIG. 4 is a block diagram illustrating an exemplary device for online to offline services according to some embodiments of the present disclosure. In some embodiments, the device 400 may be implemented as the processing engine 112 of the server 110 and/or the processor 220 of the computing device 200. The device 400 may be in communication with a storage medium (e.g., the storage 150 of the system 100), and may execute instructions stored in the storage medium. In some embodiments, the device 400 may include an obtaining module 410, a target time point determination module 420, and a matching module 430.

The obtaining module 410 may obtain data from one or more components of the system 100. In some embodiments, the obtaining module 410 may obtain a first service request issued by a first service requester. The first service request may include a request time point, a start location, and a destination. In some embodiments, the first service request may be a service request that has not been accepted by a service provider. In some embodiments, the first service request may be a request for an online to offline service, such as the transportation service. The transportation service may include a car-hailing service, a chauffeur service, a delivery service, a bus service, or the like, or a combination thereof. In some embodiments, the first service request may be a request for a sharable service. As used herein, a shareable service refers to a service that is allowed to be combined with one or more other services requested by other service requesters. For example, the first service request may be a request for a carpooling service, a food delivery service, or the like, or any combination thereof. In some embodiments, the obtaining module 410 may obtain one or more candidate service requests. In some embodiments, the one or more candidate service requests may be one or more sharable service requests, including at least one of one or more first candidate service requests or one or more second candidate service requests. The one or more first candidate service requests may be waiting to be allocated to one or more candidate service providers. The one or more second candidate service requests may have been accepted by one or more candidate service providers but have not been completed. In some embodiments, the obtaining module 410 may obtain a first input or a second input by the first service requester. The first input may indicate that the first service requester agrees with a delay of executing the matching process based on the first service request and the one or more candidate service requests. The second input may indicate that the first service requester agrees with executing the matching process in real time based on the first service request and the one or more candidate service requests. In some embodiments, the obtaining module 410 may obtain first reference information and second reference information.

The target time point determination module 420 may determine a target time point. The target time point may be after the request time point. As used herein, the term “target time point” refers to a time point when the matching module 430 starts to execute a matching process for determining a service request set and a target service provider target service. In some embodiments, the target matching module 430 may execute the matching process in real time, starting at the target time point. The target time point may be relatively close to the request time point. In this case, the determination of the target time point may be related to a speed of data transmission between the server 110 and the requester terminal 130, a responding speed of the requester terminal 130, and/or other factors. In some embodiments, the matching module 430 may delay executing the matching process at the target time point.

In some embodiments, the target time point determination module 420 may determine whether the matching module 430 executes the matching process in real time or delays executing the matching process based on the input by the first service requester. The input may include the first input and the second input. In some embodiments, the target time point determination module 420 may determine whether the matching module 430 executes the matching process in real time or delays executing the matching process based on the first reference information. For instance, the target time point determination module 420 may determine a probability that the first service requester agrees with a delay of executing the matching process based on the first reference information. The target time point determination module 420 may further compare the probability with a probability threshold. For example, when the first probability is greater than the probability threshold, the target time point determination module 420 may determine to delay executing the matching process. As another example, when the first probability is less than or equal to the probability threshold, the target time point determination module 420 may determine to execute the matching process in real time.

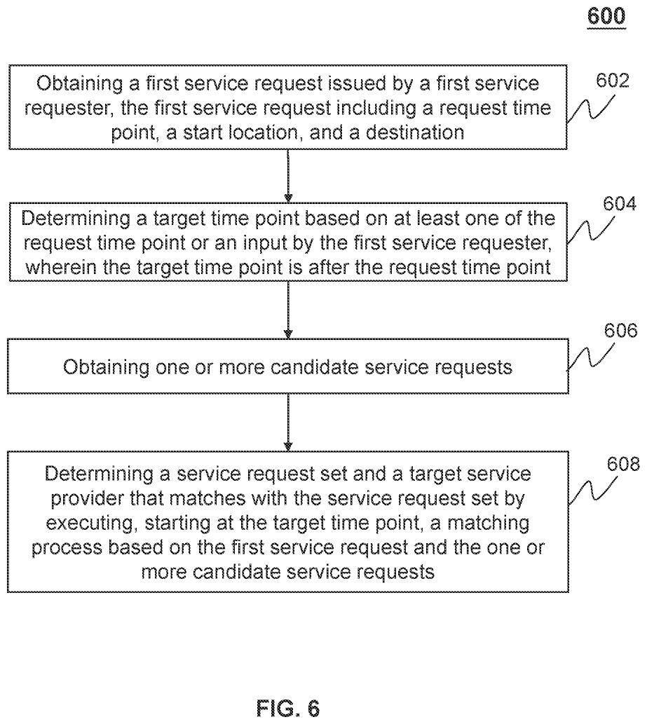

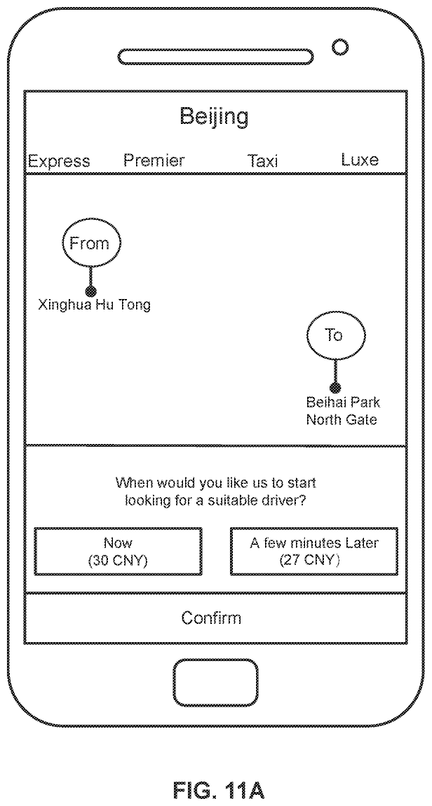

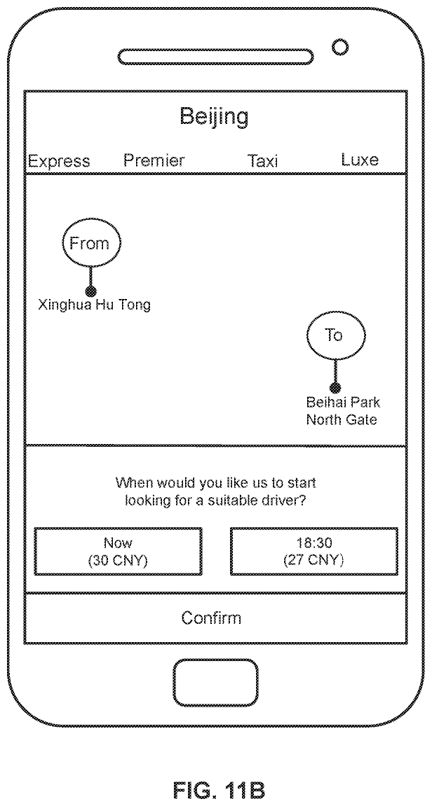

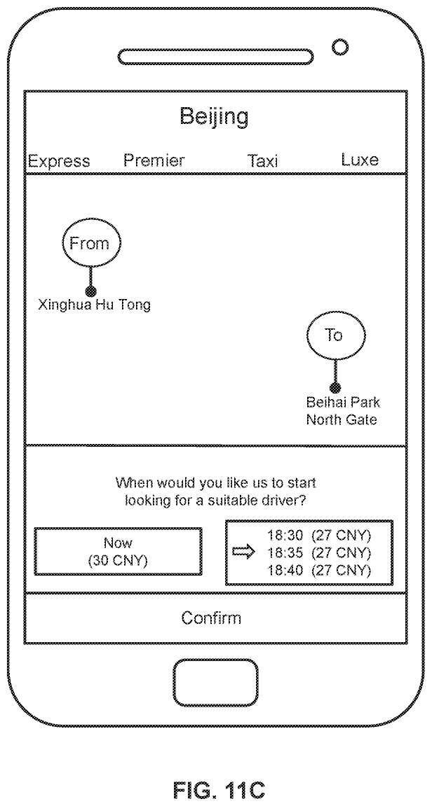

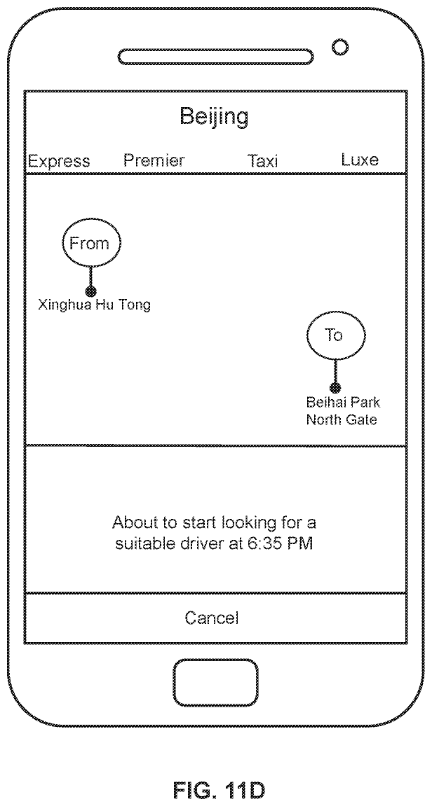

In some embodiments, in response to a determination of delaying executing the matching process, the target time point determination module 420 may determine the target time point based on the request time point. For example, the target time point determination module 420 may obtain a set of predetermined time points and determine the target time point from the set of predetermined time points. The target time point may be after the request time point. Merely by way of example, the request time point may be 18:27, the predetermined time points that are close to the request time point may be 18:25, 18:30, 18:35. The target time point determination module 420 may select the predetermined time point that is closest to the request time point and is after the request time point as the target time point (e.g., 18:30). As another example, the target time point determination module 420 may determine a time point after a predetermined time interval (e.g., 3 min, 5 min) from the request time point as the target time point. In some embodiments, the requester terminal 130 may present a subset of predetermined time points to the user, which are close to and after the request time point and are selected from the set of predetermined time points. The user may select a predetermine time point from the subset of predetermined time points as the target time point. In some embodiments, the target time point determination module 420 may estimate a waiting time period that the first service requester is willing to wait from the request time point to the target time based on second reference information. The target time point determination module 420 may further determine the target time point based on the waiting time period and the request time point. Similarly, the target time point determination module 420 may obtain the set of predetermined time points and determine the target time point from the set of predetermined time points. More details regarding the determination of the target time point may be found elsewhere in the present disclosure, for example, in the description associated with FIGS. 6-9 and/or FIGS. 11A-11D.

The matching module 430 may determine a service request set and a target service provider that matches with the service request set. In some embodiments, the matching module 430 may execute, starting at the target time point, the matching process based on the first service request and the one or more candidate service requests. When the matching module 430 determines one or more second service requests that matches with the first service request from the one or more candidate service requests, the service request set may include the first service request and the one or more second service requests. For instance, the service request set may be a carpooling service request set. When the matching module 430 determines that none of the one or more candidate service requests is matched with the first service request, the service request set may include only the first service request.

In some embodiments, the service request set and the target service provider may be determined in a single matching process. For example, when the one or more second service requests matching with the first service request are determined in the matching process, if a candidate service provider has accepted at least one of the one or more second service requests, the candidate service provider may be determined as the target service provider. In some embodiments, the matching process may include a first matching process for determining the service request set and a second matching process for determining the target service provider. The processing engine 112 may execute the first matching process for determining the service request set based on information associated with the first service request and the one or more candidate service requests. The information associated with the first service request and the one or more candidate service requests may include the start location of the first service request, the destination of the first service request, one or more start locations of the one or more candidate service requests, one or more destinations of the one or more candidate service requests, or the like, or any combination thereof.

In some embodiments, the target service provider may be determined from one or more candidate service providers. The one or more candidate service providers may include at least one of one or more first candidate service providers or one or more second candidate service providers. The one or more first candidate service providers may have accepted at least one of the one or more second candidate service requests and have not completed the at least one of the one or more second candidate service requests. The one or more second candidate service providers may not be providing any service. In other words, the one or more second candidate service providers may be waiting to be allocated with a service request and have not accepted any service requests. In some embodiments, a distance between the start location of the first service request and the location of each of the one or more candidate service providers may be less than a predetermined distance. Additionally or alternatively, a driving time from the location of each of the one or more candidate service providers to the start location of the first service request may be less than a predetermined time.

In some embodiments, after the first matching process for determining the service request set, the matching module 430 may further determine a second matching process for determining the target service provider from the one or more candidate service providers. In some embodiments, the matching module 430 may obtain first feature information of each of the one or more candidate service providers and second feature information associated with the service request set. The first feature information may include location information, a service status, a route, historical service data, a service score, or the like, or any combination thereof. The service status may indicate the availability of the candidate service provider to accept one or more additional service requests. For example, the service status may include whether the candidate service provider has accepted one or more service requests to be completed, a count of passengers on a vehicle associated with the candidate service provider, a weight and/or volume of goods on the vehicle associated with the candidate service provider, or the like, or any combination thereof. The second feature information associated with the service request set may include the start location of the first service request, the destination of the first service request, user information of the first service requester (e.g., the gender, the age), or the like, or any combination thereof. In some embodiments, the second feature information associated with the service request set may further include one or more start locations of one or more second service requests that match with the first service request, one or more destinations of the one or more second service requests, user information (e.g., the gender, the age) of one or more second service requesters who have issued the one or more second service requests, or the like, or any combination thereof.

For each of the one or more candidate service providers, the matching module 430 may determine a matching degree between the candidate service provider and the service request set based on the first feature information of the candidate service provider and the second feature information associated with the service request set. Merely by way of example, the matching module 430 may determine the matching degree for each of the one or more candidate service providers using a machine learning model. For instance, the machine learning model may include a deep belief network (DBN), a Stacked Auto-Encoders (SAE), a logistic regression (LR) model, a support vector machine (SVM) model, a decision tree model, a Naive Bayesian Model, a random forest model, or a Restricted Boltzmann Machine (RBM), a Gradient Boosting Decision Tree (GBDT) model, a Lam bdaMART model, an adaptive boosting model, a recurrent neural network (RNN) model, a convolutional network model, a hidden Markov model, a perceptron neural network model, a Hopfield network model, or the like, or any combination thereof. The matching module 430 may further determine, based on the one or more matching degrees, the target service provider from the one or more candidate service providers. For instance, the matching module 430 may determine the candidate service provider corresponding to the highest matching degree as the target service provider.

The modules in FIG. 4 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. In some embodiments, two or more of the modules may be combined into a single module, and any one of the modules may be divided into two or more units. For example, the device for online to offline services may further include a message generation module configured to generate a message. The message may be configured to notify the first service requester of a processing progress associated with the first service request. The processing progress may include a processing status of the first service request at the target time point.

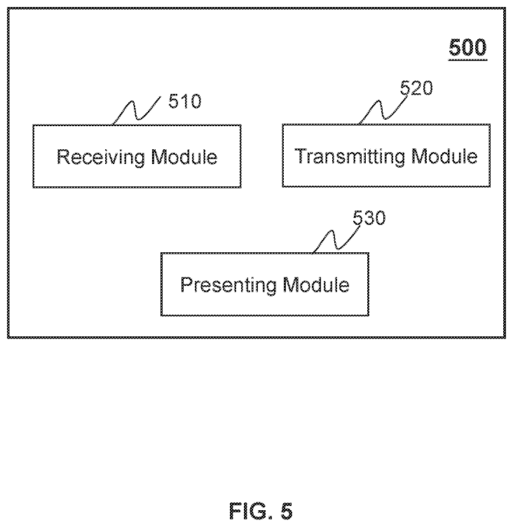

FIG. 5 is a block diagram illustrating an exemplary device for online to offline services according to some embodiments of the present disclosure. In some embodiments, the device 500 may be implemented as the CPU 340 of the terminal device 300 (e.g., the requester terminal 130). The device 500 may be in communication with a storage medium (e.g., the storage 390 and/or the memory 360 of the terminal device 300), and may execute instructions stored in the storage medium. In some embodiments, the device 500 may include a receiving module 510, a transmitting module 520, and a presenting module 430.

The receiving module 510 may receive data form one or more components of the system 100. In some embodiments, the receiving module 510 may receive a first service request issued by a first service requester. In some embodiments, the receiving module 510 may receive the first input or the second input by the first service requester. In some embodiments, the receiving module 510 may receive a processing progress associated with the first service request from the server 110. The processing progress may include a processing status of the first service request at a target time point. In some embodiments, the processing progress may include a planned progress and/or a current progress. For instance, the planned progress may include a processing status that the matching process will start at the target time point. As another example, the current progress may include a processing status that currently at the target time point, the matching process is being executed. Additionally or alternatively, the current progress may include that currently at the target time point, the server 110 is looking for another service requester (e.g., another passenger) and/or the target service provider. In some embodiments, the receiving module 510 may receive a message that notifies the first service requester of the processing progress of the first service request.

The transmitting module 520 may transmit data to one or more components of the system 100. In some embodiments, the transmitting module 520 may transmit the first service request to the server 110. For example, the first service request may be encoded by signals, and the signals may be transmitted to the server 110. In some embodiments, the transmitting module 520 may further transmit the first input or the second input to the server 110.

The presenting module 530 may present data to the first service requester via a user interface. In some embodiments, the presenting module 530 may present a first option and a second option to the first service requester via the user interface before or after the first service requester issues the first service request. The first option may indicate that the first service requester agrees with a delay of executing the matching process. The first input by the first service requester may include selecting the first option. Additionally or alternatively, the first option may include a set pf predetermined time points. The first input may include selecting a predetermined time point from the set of predetermined time points as the target time point. The second option may indicate that the first service requester agrees with executing, in real time, the matching process. The second input by the first service requester may include selecting the second option. In some embodiments, different prices for the first option and the second option may be displayed on the user interface. Since the first service requester needs to wait for a longer time if he/she selects the first option, the price for the first option may be lower than the price for the second option.

In some embodiments, the presenting module 530 may present the processing progress to the first service requester via a user interface. In some embodiments, the presenting module 530 may receive a message from the server 110 that is configured to notify the first service requester of the processing progress. The message may be generated by the server 110 in the form of a text, a speech, a graph, an animation, a video, etc. The presenting module 530 may directly present the message to the first service requester. Alternatively, the presenting module 530 may present the processing progress to the first service requester based on the message. For instance, the message received from the server 110 may be in the form of a text, the presenting module 530 may generate a modified message in the form of a different text, a speech, an animation, a graph, a video, etc. The processing engine 112 may further present the processing progress to the first service requester by presenting the modified message to the first service requester via the user interface.

The modules in FIG. 5 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. In some embodiments, two or more of the modules may be combined into a single module, and any one of the modules may be divided into two or more units.

FIG. 6 is a flowchart illustrating an exemplary process for online to offline services according to some embodiments of the present disclosure. The process 600 may be executed by one or more components of the system 100, such as the processing engine 112 of the server 110. For example, the process 600 may be implemented as a set of instructions (e.g., an application) stored in a storage (e.g., the ROM 230 or the RAM 240 of the computing device 200). The processing engine 112 and/or the modules in FIG. 4 may execute the set of instructions, and when executing the instructions, the processing engine 112 and/or the modules may be configured to perform the process 600. The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting.

In 602, the processing engine 112 (e.g., the obtaining module 410) may obtain a first service request issued by a first service requester. The first service request may include a request time point, a start location, and a destination. In some embodiments, the first service request may be a service request that has not been accepted by a service provider. The first service request may issue the first service request via a terminal device (e.g., the requester terminal 130). The terminal device may include a mobile phone, a smart watch, a tablet computer, or the like, or any combination thereof.

In some embodiments, the first service request may be a request for an online to offline service, such as a transportation service. The transportation service may include a car-hailing service, a chauffeur service, a delivery service, a bus service, or the like, or a combination thereof. For instance, the transportation service may include taking a subject from one location (e.g., the start location) to another location (e.g., the destination) using a vehicle. The subject may include passengers and/or goods. The vehicle relating to the transportation service may include a taxi, a private car, a hitch, a bus, a bike, an electric bicycle, a tricycle, a motorcycle, a train, a bullet train, a high-speed rail, a subway, a vessel, an aircraft, a spaceship, a hot-air balloon, a driverless vehicle, or the like, or any combination thereof.

In some embodiments, the start location and/or the destination may be a specified location inputted by the first service requester through the requester terminal 130 (e.g., the I/O 350 in FIG. 3). In some embodiments, the requester terminal 130 may automatically obtain the start location and/or the destination. For example, an event such as “A meeting at location A at 10:00 a.m. on Oct. 13, 2017” may be recorded in a calendar in the requester terminal 130. The requester terminal 130 may automatically determine location A as the destination based on the event in the calendar. In some embodiments, the requester terminal 130 may obtain its location (which is referred to as the location of the service requester) herein through a positioning technology, for example, the GPS, GLONASS, COMPASS, QZSS, BDS, WiFi positioning technology, or the like, or any combination thereof. An application (e.g., a car-hailing application) installed in the requester terminal 130 may direct the requester terminal 130 to transmit, continuously or periodically, the real-time location of the first service requester to the server 110. Consequently, the server 110 may obtain the location of the service requester in real time or substantially real time.

In some embodiments, the first service request may be a request for a sharable service. As used herein, a shareable service refers to a service that is allowed to be combined with one or more other services requested by other service requesters. For example, the first service request may be a request for a carpooling service, a food delivery service, or the like, or any combination thereof.

In 604, the processing engine 112 (e.g., the target time point determination module 420) may determine a target time point based on at least one of the request time point or an input by the first service requester. The target time point may be after the request time point. As used herein, the term “target time point” refers to a time point when the processing engine 112 starts to execute a matching process for determining a service request set and a target service provider target service (as will be described in operation 608).

In some embodiments, the processing engine 112 may execute the matching process in real time or substantially real time, starting at the target time point. For example, as soon as the first service request is obtained by the processing engine 112, the processing engine 112 may start executing the matching process. As another example, the processing engine 112 may execute the matching process after a relatively short time period (e.g., 1 s, 2 s, 3 s) after the first service request is obtained. The target time point may be relatively close to the request time point. In this case, the determination of the target time point may be related to a speed of data transmission between the server 110 and the requester terminal 130, a responding speed of the requester terminal 130, and/or other factors. In some embodiments, the processing engine 112 may delay executing the matching process at the target time point. For instance, after the processing engine 112 obtains the first service request, instead of starting to execute the matching process in real time, the processing engine 112 may wait until the target time point, and then start to execute the matching process.

In some embodiments, the processing engine 112 may determine whether to execute the matching process in real time or delay executing the matching process based on the input by the first service requester. The input may include a first input indicating that the first service requester agrees with a delay of executing the matching process. Alternatively, the input may include a second input indicating that the first service requester agrees with executing the matching process in real time.

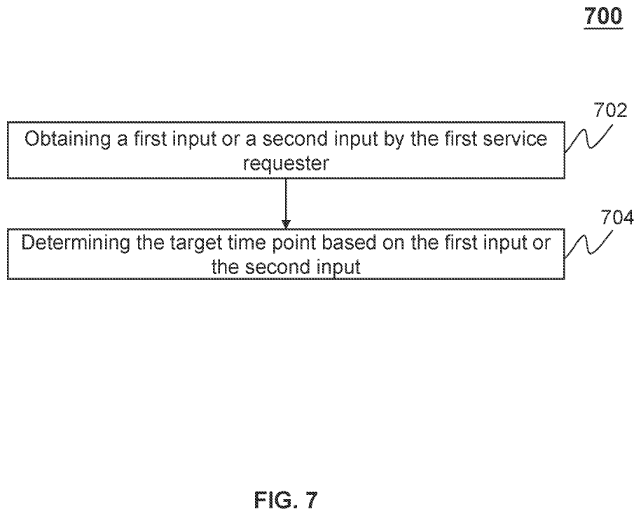

As compared to separate requests for online to offline services, the request service set including combined sharable services may reduce the usage of resources (e.g., vehicles, fuel). When multiple matching processes associated with multiple service requests are delayed to be executed at the same target time point, there may be more candidate service requests and candidate service providers. As a result, a probability of finding one or more second service requests that match with the first service request may be improved. Additionally or alternatively, a matching extent between the one or more second service requests and the first service request may be increased. For example, the first service request may share a larger portion of a trip (from the start location to the destination) with the one or more second service requests. In some embodiments, the price for the first service request may be different depending on executing the matching process in real time or a delay of executing the matching process. The different prices may be presented to the first service requester via the user interface. Since the first service requester needs to wait for a longer time if he/she agrees with the delay of executing the matching process, the price associated with a delayed execution of the matching process may be lower than the price associated with a real-time execution of the matching process, which may compensate the time loss of the first service requester. More details regarding the input by the first service request may be found elsewhere in the present disclosure, for example, in the description associated with FIG. 7 and/or FIGS. 11A-11D.

In some embodiments, the processing engine 112 may determine whether to execute the matching process in real time or delay executing the matching process based on first reference information. For instance, the processing engine 112 may determine a probability that the first service requester agrees with a delay of executing the matching process based on the first reference information. The processing engine 112 may further compare the probability with a probability threshold. For example, when the first probability is greater than the probability threshold, the processing engine 112 may determine to delay executing the matching process. As another example, when the first probability is less than or equal to the probability threshold, the processing engine 112 may determine to execute the matching process in real time.

In some embodiments, in response to a determination of delaying executing the matching process, the processing engine 112 may determine the target time point based on the request time point. For example, the processing engine 112 may obtain a set of predetermined time points and determine the target time point from the set of predetermined time points. The target time point may be after the request time point. Merely by way of example, the request time point may be 18:27, the predetermined time points that are close to the request time point may be 18:25, 18:30, 18:35. The processing engine 112 may select the predetermined time point that is closest to the request time point and is after the request time point as the target time point (e.g., 18:30). As another example, the processing engine 112 may determine a time point after a predetermined time interval (e.g., 3 min, 5 min) from the request time point as the target time point. In some embodiments, the requester terminal 130 may present a subset of predetermined time points to the user, which are close to and after the request time point and are selected from the set of predetermined time points. The user may select a predetermine time point from the subset of predetermined time points as the target time point. In some embodiments, the processing engine 112 may estimate a waiting time period that the first service requester is willing to wait from the request time point to the target time based on second reference information. The processing engine 112 may further determine the target time point based on the waiting time period and the request time point. Similarly, the processing engine 112 may obtain the set of predetermined time points and determine the target time point from the set of predetermined time points. More details regarding the determination of the target time point may be found elsewhere in the present disclosure, for example, in the description associated with FIGS. 7-9 and/or FIGS. 11A-11D.

In 606, the processing engine 112 (e.g., the obtaining module 410) may obtain one or more candidate service requests. In some embodiments, the one or more candidate service requests may be one or more sharable service requests, including at least one of one or more first candidate service requests or one or more second candidate service requests.

The one or more first candidate service requests may be pending to be allocated to one or more candidate service providers. The one or more second candidate service requests may have been accepted by one or more candidate service providers but have not been completed. Additionally, the one or more candidate service providers may be available to accept another service request (e.g., the first service request). For example, a driver (i.e., a candidate service provider) may have accepted two second candidate service requests associated with two passengers. The vehicle associated with the driver may be capable of taking one or two additional passengers corresponding to the first service request. Thus, if the count of passengers corresponding to the first service request is one or two, the driver may be determined as available to accept the first service request. In some embodiments, the processing engine 112 may obtain the one or more candidate service requests in a time interval between the request time point and the target time point. The one or more candidate service requests may be issued by one or more service requesters before the target time point. In some embodiments, the processing engine 112 may further obtain information associated with the one or more candidate service requests, including but not limited to one or more start locations, destinations, processing status, routes, user identification numbers (e.g., passenger identification numbers and/or driver identification numbers), location information at the target time point, or the like, or any combination thereof.

In 608, the processing engine 112 (e.g., the matching module 430) may determine a service request set and a target service provider that matches with the service request set by executing, starting at the target time point, a matching process based on the first service request and the one or more candidate service requests. When the processing engine 112 determines one or more second service requests that matches with the first service request from the one or more candidate service requests, the service request set may include the first service request and the one or more second service requests. For instance, the service request set may be a carpooling service request set. When the processing engine 112 determines that none of the one or more candidate service requests is matched with the first service request, the service request set may include only the first service request.

In some embodiments, the service request set and the target service provider may be determined by a single matching process. For example, when the one or more second service requests matched with the first service request are determined in the matching process, if a candidate service provider has accepted at least one of the one or more second service requests, the candidate service provider may be determined as the target service provider. In some embodiments, the matching process may include a first matching process for determining the service request set and a second matching process for determining the target service provider. The processing engine 112 may execute the first matching process for determining the service request set based on information associated with the first service request and the one or more candidate service requests. The information associated with the first service request and the one or more candidate service requests may include the start location of the first service request, the destination of the first service request, one or more start locations of the one or more candidate service requests, one or more destinations of the one or more candidate service requests, or the like, or any combination thereof.

In some embodiments, the target service provider may be determined from one or more candidate service providers. The one or more candidate service providers may include at least one of one or more first candidate service providers or one or more second candidate service providers. The one or more first candidate service providers may have accepted at least one of the one or more second candidate service requests and have not completed the at least one of the one or more second candidate service requests. The one or more second candidate service providers may not be providing any service. In other words, the one or more second candidate service providers may be waiting to be allocated with a service request and have not accepted any service request. In some embodiments, a distance between the start location of the first service request and the location of each of the one or more candidate service providers may be less than a predetermined distance. Additionally or alternatively, a driving time from the location of each of the one or more candidate service providers to the start location of the first service request may be less than a predetermined time.

In some embodiments, after the first matching process for determining the service request set, the processing engine 112 may further determine a second matching process for determining the target service provider that matches with the service request. In some embodiments, the processing engine 112 may obtain first feature information of each of the one or more candidate service providers and second feature information associated with the service request set. The first feature information may include location information, a service status, a route, historical service data, a service score, or the like, or any combination thereof. The service status may indicate the availability of the candidate service provider to accept one or more additional service requests. For example, the service status related to a transportation service may include whether the candidate service provider has accepted one or more service requests to be completed, a count of passengers on a vehicle associated with the candidate service provider, a weight and/or volume of goods on the vehicle associated with the candidate service provider, or the like, or any combination thereof. The second feature information associated with the service request set may include the start location of the first service request, the destination of the first service request, user information of the first service requester (e.g., the gender, the age), or the like, or any combination thereof. In some embodiments, the second feature information associated with the service request set may further include one or more start locations of one or more second service requests that match with the first service request, one or more destinations of the one or more second service requests, user information (e.g., the gender, the age) of one or more second service requesters who have issued the one or more second service requests, or the like, or any combination thereof.

For each of the one or more candidate service providers, the processing engine 112 may determine a matching degree between the candidate service provider and the service request set based on the first feature information of the candidate service provider and the second feature information associated with the service request set. Merely by way of example, the processing engine 112 may determine the matching degree for each of the one or more candidate service providers using a machine learning model. For instance, the machine learning model may include a deep belief network (DBN), a Stacked Auto-Encoders (SAE), a logistic regression (LR) model, a support vector machine (SVM) model, a decision tree model, a Naive Bayesian Model, a random forest model, or a Restricted Boltzmann Machine (RBM), a Gradient Boosting Decision Tree (GBDT) model, a Lam bdaMART model, an adaptive boosting model, a recurrent neural network (RNN) model, a convolutional network model, a hidden Markov model, a perceptron neural network model, a Hopfield network model, or the like, or any combination thereof. The processing engine 112 may further determine, based on the one or more matching degrees, the target service provider from the one or more candidate service providers. For instance, the processing engine 112 may determine the candidate service provider corresponding to the highest matching degree as the target service provider.

In some embodiments, the processing engine 112 may generate a message. The message may be configured to notify the first service requester of a processing progress associated with the first service request. The message may be transmitted to the requester terminal 130. The processing progress may include a processing status of the first service request at the target time point. In some embodiments, the processing progress may include a planned progress and/or a current progress. For instance, the message corresponding to a planned progress may be configured to notify the first service requester that the matching process will start at the target time point. As another example, the message corresponding to the current progress may be configured to notify the first service requester that currently at the target time point, the matching process is being executed. Additionally or alternatively, the message may be configured to notify the first service requester that currently at the target time point, the server 110 is looking for another service requester (e.g., another passenger) and/or the target service provider.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure. For example, other methods for determining the one or more second service requests and/or the target service provider that match(es) with the first service request, which are not mentioned in the present disclosure, may be applied in the operation 608.

FIG. 7 is a flowchart illustrating an exemplary process for determining a target time point based on an input by the first service requester according to some embodiments of the present disclosure. The process 700 may be executed by one or more components of the system 100, such as the processing engine 112. The processing engine 112 may be implemented in the server 110 or the terminal device 300. For example, the process 700 may be implemented as a set of instructions (e.g., an application) stored in a storage (e.g., the ROM 230 or the RAM 240 of the computing device 200, or the storage 390 of the terminal device 300). The processing engine 112 and/or the modules in FIG. 4 may execute the set of instructions, and when executing the instructions, the processing engine 112, the CPU 340, and/or the modules may be configured to perform the process 700. The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting.

In 702, the processing engine 112 (e.g., the obtaining module 410) may obtain a first input or a second input by the first service requester. The first input may indicate that the first service requester agrees with a delay of executing the matching process based on the first service request and the one or more candidate service requests. The second input may indicate that the first service requester agrees with executing the matching process in real time. The requester terminal 130 may receive the first input or the second input by the first service requester and transmit the first input or the second input to the processing engine 112 implemented on the server 110. For instance, the first service requester may input information via the requester terminal 130 by clicking on a button. As another example, the first service requester may input information via the requester terminal by speaking to a microphone of the requester terminal 130. More examples regarding user interfaces associated with the first input and/or the second input may be found elsewhere in the present disclosure, for example, in FIGS. 11A-11C.

In 704, the processing engine 112 (e.g., the target time point module 420) may determine the target time point based on the first input or the second input. In some embodiments, in response to a determination that the first input is received, the processing engine 112 may determine to delay executing the matching process based on the first service request and the one or more candidate service requests. The processing engine 112 may further determine the target time point based on the request time point. For example, the processing engine 112 may select a predetermined time point from the set of predetermined time points as the target time point. As another example, the processing engine 112 may determine a time point after a predetermined time interval (e.g., 3 min, 5 min) from the request time point as the target time point. As yet another example, the processing engine 112 may estimate a waiting time period that the first service requester is willing to wait from the request time point to the target time based on the second reference information. The processing engine 112 may further determine the target time point based on the waiting time period and the request time point. In some embodiments, the first input may include selecting a predetermined time point from a subset of predetermined time points as the target time point. The subset of predetermined time points may be close to the request time point and after the request time point.

In some embodiments, in response to a determination that the second input is received, the processing engine 112 may determine to execute the matching process in real time. The target time point may be a time point that is relatively close to the request time point. The determination of the target time point may be related to a speed of data transmission between the server 110 and the requester terminal 130, a responding speed of the requester terminal 130, and/or other factors.

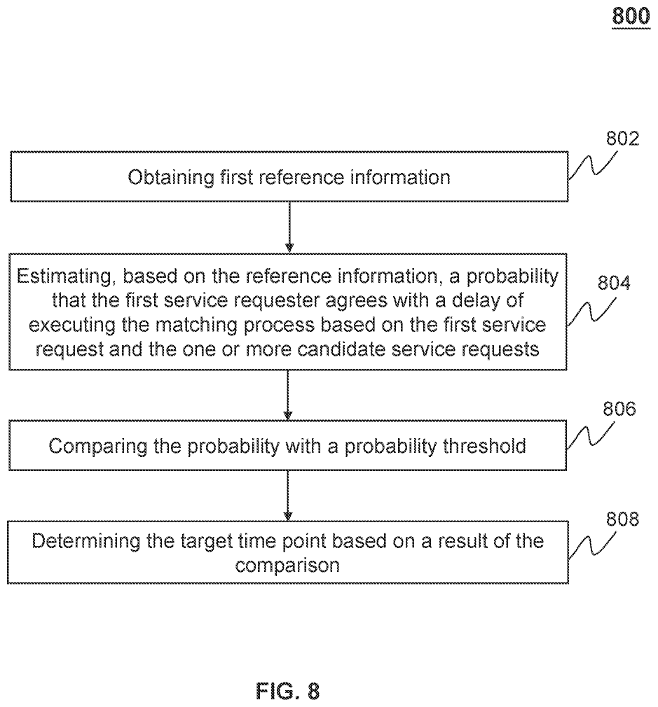

FIG. 8 is a flowchart illustrating an exemplary process for determining a target time point based on first reference information according to some embodiments of the present disclosure. The process 800 may be executed by one or more components of the system 100, such as the processing engine 112 of the server 110. For example, the process 800 may be implemented as a set of instructions (e.g., an application) stored in a storage (e.g., the ROM 230 or the RAM 240 of the computing device 200). The processing engine 112 and/or the modules in FIG. 4 may execute the set of instructions, and when executing the instructions, the processing engine 112, the CPU 340, and/or the modules may be configured to perform the process 800. The operations of the illustrated process 800 presented below are intended to be illustrative. In some embodiments, the process 800 may be accomplished with one or more additional operations not described, and/or without one or more of the operations discussed. Additionally, the order in which the operations of the process 800 as illustrated in FIG. 8 and described below is not intended to be limiting.

In 802, the processing engine 112 (e.g., the obtaining module 410) may obtain first reference information. The first reference information may be associated with the first service request and/or the first service requester. The first reference information may be used to determine whether to execute the matching process for determining the service request set and the target service provider in real time or delay executing the matching process. Merely by way of example, the first reference information may include the start location of the first service request, a weather condition, a traffic condition, preference information of the first service requester, or one or more historical service requests of the first service requester, or the like, or any combination thereof.

In some embodiments, the weather condition and the traffic condition may be related to the target time point and/or the start location of the first service request. For instance, if the weather is unpleasant (e.g., rainy, snowy, hot or freezing) in a region including the start location at the target time point, the first service requester may prefer executing the matching process in real time so that the he/she does not have to wait for a long time. As another example, if the traffic in a region including the start location at the target time point is heavily congested, the first service requester may consider it reasonable to wait for a time longer than usual.

In some embodiments, the preference information of the first service requester may include a setting that can be modified by the first service requester. For example, the setting may indicate that the first service requester would like the matching process to be executed in real time. As another example, the setting may indicate that the first service requester would like a delay of executing the matching process. The processing engine 112 may determine whether to execute the matching process in real time or delay executing the matching process according to the setting.

In some embodiments, the one or more historical service requests of the first service requester may include historical information. The one or more historical service requests may be sharable service requests. For example, the historical information may include a count of historical service requests for which the matching process is executed in real time, a count of historical service requests for which the matching process is delayed to be executed, satisfaction degrees associated with the one or more historical service requests of the first service requester, whether the first service requester has cancelled any historical service request after waiting for a certain time period for a matching process that was delayed to be executed, or the like, or any combination thereof.

In 804, the processing engine 112 (e.g., the target time point determination module 420) may estimate, based on the first reference information, a probability that the first service requester agrees with a delay of executing the matching process based on the first service request and the one or more candidate service requests. In some embodiments, the processing engine 112 may estimate the probability using a trained estimation model, such as a trained machine learning model. The processing engine 112 may input the first reference information to the trained estimation model, and the trained estimation model may output the probability. Merely by way of example, the trained machine learning model may include a DBN, a SAE, an LR model, an SVM model, a decision tree model, a Naive Bayesian Model, a random forest model, an RBM model, a GBDT model, a Lam bdaMART model, an adaptive boosting model, an RNN model, a convolutional network model, a hidden Markov model, a perceptron neural network model, a Hopfield network model, or the like, or any combination thereof.

The probability may be 0, 1, or a value between 0 to 1. In response to a determination that the value of the probability is 0, the processing engine 112 may determine to execute the matching process in real time. In response to a determination that the value of the probability is 1, the processing engine 112 may determine to delay execute the matching process. In some embodiments, for example, when the value of the probability is between 0 to 1, the processing engine 112 may proceed to operation 806.

In 806, the processing engine 112 (e.g., the target time point determination module 420) may compare the probability with a probability threshold. For instance, the probability threshold may be 0.5, 0.55, 0.6, or the like. In some embodiments, the probability threshold may be predetermined according to a default setting associated with the system 100. Alternatively, the probability threshold may be modified by an administrator associated with the system 100. In some embodiments, the probability threshold may be adjusted based on factors such as the request time point, the start location, safety, a distance between the start location and the destination of the first service request, or the like, or any combination thereof. For instance, if the request time point is early in the morning (e.g., 06:30), the probability threshold may be decreased by a certain amount, for example, from 0.6 to 0.5. In this case, since there may be only a few candidate service requests and a few candidate service providers, the delay of executing the matching process may increase a possibility of finding one or more second service requests matched with the first service request and the target service provider. As another example, if the distance between the start location and the destination of the first service request is greater than a distance threshold, the probability threshold may be decreased. In this way, the delay of executing the matching process may be contributive to finding one or more second service requests and the target service provider, and thus the use of transportation resources may be reduced.

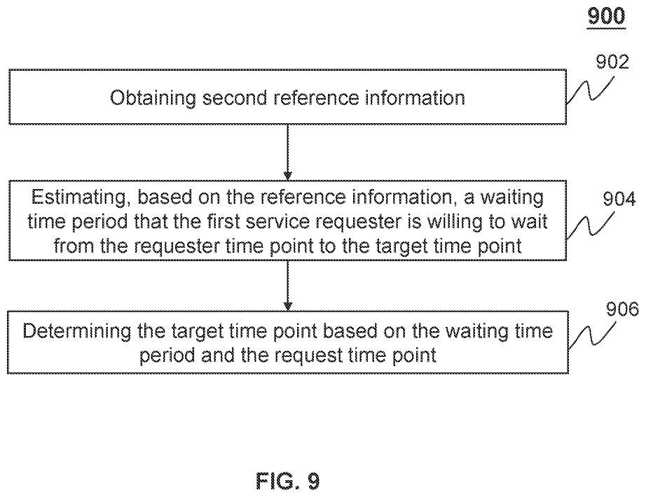

In 808, the processing engine 112 (e.g., the target time point determination module 420) may determine the target time point based on a result of the comparison. In response to a determination that the probability is greater than the probability threshold, the processing engine 112 may determine to delay executing the matching process. In response to a determination that the probability is less than or equal to the probability threshold, the processing engine 112 may determine to execute the matching process in real time. More details regarding the determination of the target time point may be found elsewhere in the present disclosure, for example, in FIG. 6, FIG. 9 and/or FIGS. 11A-11D.

FIG. 9 is a flowchart illustrating an exemplary process for determining a target time point based on second reference information according to some embodiments of the present disclosure. The process 900 may be executed by one or more components of the system 100, such as the processing engine 112 of the server 110. For example, the process 900 may be implemented as a set of instructions (e.g., an application) stored in a storage (e.g., the ROM 230 or the RAM 240 of the computing device 200). The processing engine 112 and/or the modules in FIG. 4 may execute the set of instructions, and when executing the instructions, the processing engine 112, the CPU 340, and/or the modules may be configured to perform the process 900. The operations of the illustrated process 900 presented below are intended to be illustrative. In some embodiments, the process 900 may be accomplished with one or more additional operations not described, and/or without one or more of the operations discussed. Additionally, the order in which the operations of the process 900 as illustrated in FIG. 9 and described below is not intended to be limiting.

In 902, the processing engine 112 (e.g., the obtaining module 410) may obtain second reference information. The second reference information may be used to estimate a waiting time period that the first service requester is willing to wait from the request time point to the target time point. For instance, the second reference information may include the start location of the first service request, a weather condition, a traffic condition, preference information of the first service requester, one or more historical service requests of the first service requester, one or more historical service requests of other service requesters, or the like, or any combination thereof. The one or more historical service requests may be one or more sharable service requests. Merely by way of example, the one or more historical service requests of the first service requester and/or other service requesters may include one or more historical time periods that the first service requester and/or other service requesters waited from one or more historical request time point to one or more corresponding historical target time points. Additionally or alternatively, the one or more historical service requests may include a count of historical service requests for which the matching process is executed in real time, a count of historical service requests for which the matching process is delayed to be executed, one or more satisfaction degrees associated with the one or more historical service requests, whether the one or more historical service requests were cancelled after waiting for a certain time period in a case where the matching process was delayed to be executed, or the like, or any combination thereof.

In 904, the processing engine 112 (e.g., the target time point determination module 420) may estimate, based on the second reference information, a waiting time period that the first service requester is willing to wait from the request time point to the target time point. As used herein, the waiting time period may be considered as an estimated time threshold. If the first service requester needs to wait for a time longer than the waiting time period, the first service requester may tend to cancel the first service request or change the type of the first service request from a sharable service request to a non-sharable service request.

In some embodiments, the waiting time period may be a first average time period that the first service requester waits for a sharable service request. The processing engine 112 may determine the first average time period based on one or more historical time periods that the first service requester waited from one or more historical request time point to one or more corresponding historical target time points. In some embodiments, the waiting time period may be a second average time period that the first service requester and other service requesters waits for a sharable service request. The processing engine 112 may determine the second average time period based on one or more historical time periods from one or more historical request time point to one or more corresponding historical target time points.

In some embodiments, the processing engine 112 may determine the waiting time period using a trained machine learning model. For instance, the processing engine 112 may input the second reference information to the trained machine learning model to obtain the waiting time period. The machine learning model may be trained using a plurality of training samples. Each of the plurality of training samples may include historical second reference information and a label that indicates a historical time period that the first service requester and/or another service requester waited from the request time point to the target time point. Merely by way of example, the machine learning model may include a DBN, a SAE, an LR model, an SVM model, a decision tree model, a Naive Bayesian Model, a random forest model, an RBM model, a GBDT model, a LambdaMART model, an adaptive boosting model, an RNN model, a convolutional network model, a hidden Markov model, a perceptron neural network model, a Hopfield network model, or the like, or any combination thereof.

In 906, the processing engine 112 (e.g., the target time point determination module 420) may determine the target time point based on the waiting time period and the request time point. The target time point may be determined such that the time difference between the target time point and the request time point may be less than or equal to the waiting time period. For instance, the processing engine 112 may determine a reference time point that is after the request time period. The time difference between the reference time point and the request time point may be equal to the waiting time period. The target time point may be before the reference time point. For example, the processing engine 112 may determine a predetermined time point that is closest to the reference time point and is before the reference time point as the target time point. Merely by way of example, if the request time point is 18:27, the waiting time period is 6 min, and the set of predetermined time points include 18:25, 18:30, 18:35, the processing engine 112 may determine 18:30 as the target time point, since 18:30 is before the reference time point 18:33.

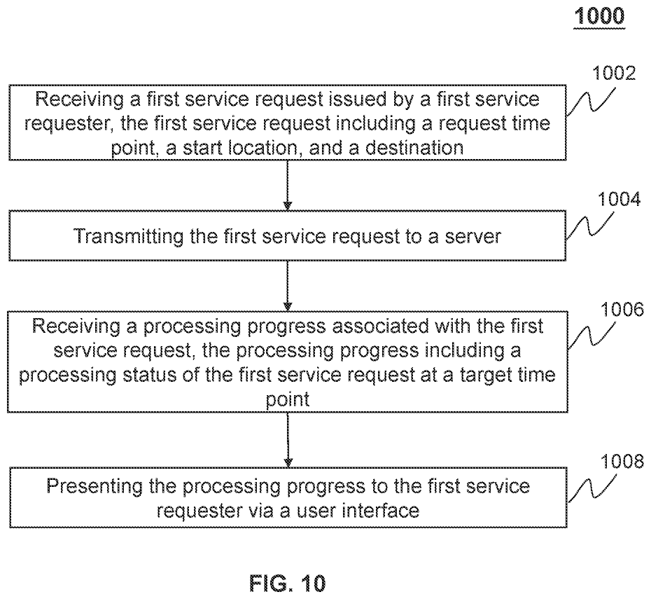

FIG. 10 is a flowchart illustrating an exemplary process for online to offline services according to some embodiments of the present disclosure. The process 1000 may be executed by one or more components of the system 100, such as the requester terminal 130. For example, the process 1000 may be implemented as a set of instructions (e.g., an application) stored in a storage (e.g., the storage 390 and/or the memory 360 of the terminal device 300). In some embodiments, the process 1000 may be implemented by a processing engine 112 that is implemented on the requester terminal 130, such as the CPU 340. The processing engine 112 and/or the modules in FIG. 5 may execute the set of instructions, and when executing the instructions, the processing engine 112 and/or the modules may be configured to perform the process 1000. The operations of the illustrated process 1000 presented below are intended to be illustrative. In some embodiments, the process 1000 may be accomplished with one or more additional operations not described, and/or without one or more of the operations discussed. Additionally, the order in which the operations of the process 1000 as illustrated in FIG. 10 and described below is not intended to be limiting.

In 1002, the processing engine 112 (e.g., the receiving module 510) may receive a first service request issued by a first service requester. The first service request may include a request time point, a start location, and a destination. In some embodiments, the first service request may be a request for a sharable service, such as a request for a carpooling service from the start location to the destination. In some embodiments, the first service request may be a service request that has not been accepted by a service provider.

In 1004, the processing engine 112 (e.g., the transmitting module 520) may transmit the first service request to a server (e.g., the server 110). For example, the first service request may be encoded by signals and the signals may be transmitted to the server 110. The requester terminal 130 and/or the server 110 may determine a target time point based on at least one of the request time point or an input by the first service requester, for example, according to the process 700, the process 800, and/or the process 900 in connection with FIG. 7, FIG. 8, and FIG. 9, respectively. The server 110 may determine a service request set and a target service provider that matches with the service request set by executing, starting from a target time point, a matching process based on the first service request and one or more candidate service requests.

In some embodiments, the target time point may be determined at least partly based on the input by the first service requester that is received by the requester terminal 130. In some embodiments, the processing engine 112 (e.g., the presenting module 530) may present a first option and a second option to the first service requester via the user interface before or after the first service requester issues the first service request. The first option may indicate that the first service requester agrees with a delay of executing the matching process. The first input by the first service requester may include selecting the first option. Additionally or alternatively, the first option may include a set pf predetermined time points. The first input may include selecting a predetermined time point from the set of predetermined time points as the target time point. The second option may indicate that the first service requester agrees with executing, in real time, the matching process. The second input by the first service requester may include selecting the second option. In some embodiments, different prices for the first service request associated with the first option and the second option may be displayed on the user interface. Since the first service requester needs to wait for a longer time if he/she selects the first option, the price associated with the first option may be lower than the price for the second option. The processing engine 112 may further transmit the first input or the second input to the server 110.

In 1006, the processing engine 112 (e.g., the receiving module 510) may receive a processing progress associated with the first service request. The processing progress may include a processing status of the first service request at a target time point. In some embodiments, the processing progress may include a planned progress and/or a current progress. For instance, the planned progress may include a processing status that the matching process will start at the target time point. As another example, the current progress may include a processing status that currently at the target time point, the matching process is being executed. Additionally or alternatively, the current progress may include that currently at the target time point, the server 110 is looking for another service requester (e.g., another passenger) and/or the target service provider.

In 1008, the processing engine 112 (e.g., the presenting module 530) may present the processing progress to the first service requester via a user interface. In some embodiments, the processing engine 112 may receive a message from the server 110 that is configured to notify the first service requester of the processing progress. The message may be generated by the server 110 in the form of a text, a speech, a graph, an animation, a video, etc. The processing engine 112 may directly present the message to the first service requester. Alternatively, the processing engine 112 may present the processing progress to the first service requester based on the message, as will be described in FIG. 11D. As another example, the message received by the processing engine 112 may be in the form of a text, the processing engine 112 may generate a modified message in the form of a different text, a speech, an animation, a graph, a video, etc. The processing engine 112 may further present the processing progress to the first service requester by presenting the modified message to the first service requester via the user interface implemented on the requester terminal 130.

FIGS. 11A-11D are schematic diagrams illustrating exemplary user interfaces for online to offline services according to some embodiments of the present disclosure. The user interfaces may be implemented on the requester terminal 130, for example, as the user interfaces of a car-hailing application installed on the requester terminal 130.

As shown in FIGS. 11A-11D, a city where the first service requester is located and a plurality of business lines may be displayed via the user interfaces. For example, the city may be Beijing. The plurality of business lines may include different types of services, such as the Express service, the Premier service, the Taxi service, the Luxe service, etc. The first service requester may modify the city and/or select a business line from the plurality of business lines. A start location marked by “From” and a destination marked by “To” are shown on the user interfaces. The start location and the destination may be associated with the first service request.

FIGS. 11A-11C illustrate exemplary user interfaces for presenting the first option and the second option to the first service requester. For example, a question may be displayed on the user interfaces to ask the first service requester when to start the matching process for determining the service request set and the target service provider. For the convenience of understanding by the first service requester, the question may be “When would you like us to start looking for a suitable driver?” or “When would you like us to start looking for another passenger?”, etc. As shown in FIG. 11A, the first option displayed on the interface may be “a few minutes later”, which may indicate that the first service requester agrees with a delay of executing the matching process. The second option displayed on the interface may be “Now”, which indicates that the first service requester agrees with executing, in real time, the matching process. The first service requester may select the first option (i.e., the first input) or select the second option (i.e., the second input) by clicking on a button associated with the first option or the second option. In some embodiments, different prices for the first option and the second option may be displayed on the user interface. Since the first service requester needs to wait for a longer time if he/she selects the first option, the price for the first option (e.g., 27 CNY) may be lower than the price for the second option (e.g., 30 CNY). The first service requester may further click on the “Confirm” button to confirm the selection of the first option or the second option. As shown in FIG. 11B, the first option may include a predetermined time point (e.g., 18:30). The requester terminal 130 may determine the predetermined time point from the set of predetermined time points. In response to a determination that the first option is selected, the predetermined time point may be determined as the target time point. As shown in FIG. 11C, the first option may include a subset of predetermined time points determined from the predetermined time points, such as 18:30, 18:35, 18:40, etc. The first service requester may select a predetermined time point from the subset of predetermined time points as the target time point. For example, if 18:35 is selected, an arrow may be used to mark the selected predetermined time point 18:35. After the first service requester clicks on the “confirm” button, the selected predetermined time point may be determined as the target time point. In some embodiments, the target time point may be determined based on the request time point and a waiting time period estimated by the server 110.

As shown in FIG. 11D, a planned progress at the target time point is presented via the user interface. The planned progress may include a processing status that the matching process will start at the target time point. As another example, when a user interface of another application other than the car-hailing application is displayed or when the screen of the requester terminal 130 (e.g., a mobile phone) is locked, a message may be presented to the first service requester to notify the first service requester of the planned progress and/or the current progress.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure. For example, the contents displayed on the user interfaces of the user terminal may be different from the contents shown in FIGS. 11A-11D.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for online to offline services, comprising:
at least one storage device storing a set of instructions; and
at least one processor in communication with the storage device, wherein when executing the set of instructions, the at least one processor is directed to cause the system to:
obtain a first service request issued by a first service requester, the first service request including a request time point, a start location, and a destination;
determine a target time point based on at least one of the request time point or an input by the first service requester, wherein the target time point is after the request time point;
obtain one or more candidate service requests; and
determine a service request set and a target service provider that matches with the service request set by executing, starting at the target time point, a matching process based on the first service request and the one or more candidate service requests, wherein the service request set includes the first service request.

2. The system of claim 1, wherein to determine the target time point based on the at least one of the request time point or the input by the first service requester, the at least one processor is directed to cause the system to:
obtain a first input by the first service provider; and
determine the target time point based on the first input, wherein
the first input indicates that the first service provider agrees with a delay of executing the matching process.

3. The system of claim 1, wherein to determine the target time point based on the at least one of the request time point or the input by the first service requester, the at least one processor is directed to cause the system to:
obtain first reference information;
estimate, based on the first reference information, a probability that the first service provider agrees with a delay of executing the matching process;
compare the probability with a probability threshold; and
determine the target time point based on a result of the comparison.

4. The system of claim 1, wherein to determine the target time point based on the at least one of the request time point or the input by the first service requester, the at least one processor is directed to cause the system to:
obtain second reference information;
estimate, based on the second reference information, a waiting time period that the first service requester is willing to wait from the request time point to the target time point; and
determine the target time point based on the waiting time period and the request time point.

5. The system of claim 4, wherein the second reference information includes at least one of the start location, a weather condition, a traffic condition, preference information of the first service requester, one or more historical service requests of the first service requester, or one or more historical service requests of other service requesters.

6. The system of claim 1, wherein the one or more candidate service requests are obtained between the request time point and the target time point.

7. The system of claim 1, wherein the target time point is determined from a set of predetermined time points.

8. The system of claim 1, wherein the at least one processor is directed to cause the system to:
generate a message configured to notify the first service requester of a processing progress associated with the first service request, the processing progress including a processing status of the first service request at the target time point.

9. The system of claim 1, wherein the one or more candidate service requests include at least one of one or more first candidate service requests to be allocated or one or more second candidate service requests, wherein the one or more second candidate service requests have been accepted by one or more candidate service providers but have not been completed.

10. The system of claim 1, wherein the service request set further includes one or more second service requests issued by one or more second service requesters,
the one or more second service requests are matched with the first service requests, and
the one or more second service requests are determined from the one or more candidate service requests.

11. The system of claim 1, wherein the target service provider is selected from one or more candidate service providers including at least one of one or more first candidate service providers or one or more second candidate service providers, and wherein
the one or more first candidate service providers have accepted at least one of the one or more second service requests and have not completed the at least one of the one or more second service requests, and
the one or more second candidate service providers are not providing any service.

12. The system of claim 11, wherein to select the target service provider from the one or more candidate service providers, the at least one processor is directed to cause the system to:
obtain first feature information of each of the one or more candidate service providers and second feature information associated with the service request set;
for each of the one or more candidate service providers, determine a matching degree between the candidate service provider and the service request set based on the first feature information and the second feature information; and
determine, based on the one or more matching degrees, the target service provider from the one or more candidate service providers.

13. A method for online to offline services, implemented on a computing device having at least one processor and at least one non-transitory storage medium, the method comprising:
obtaining a first service request issued by a first service requester, the first service request including a request time point, a start location; and a destination;
determining a target time point based on at least one of the request time point or an input by the first service requester, wherein the target time point is after the request time point;
obtaining one or more candidate service requests; and
determining a service request set and a target service provider that matches with the service request set by executing, starting at the target time point, a matching process based on the first service request and the one or more candidate service requests, wherein the service request set includes the first service request.

14-26. (canceled)

27. A system for online to offline services, comprising:
at least one storage device storing a set of instructions; and
at least one processor in communication with the storage device, wherein when executing the set of instructions, the at least one processor is directed to cause the system to:
receive a first service request issued by a first service requester, the first service request including a request time point, a start location, and a destination;
transmit the first service request to a server;
receive a processing progress associated with the first service request, the processing progress including a processing status of the first service request at a target time point; and
present the processing progress to the first service requester via a user interface, wherein
the target time point is determined based on at least one of the request time point or an input by the first service requester, and wherein the target time point is after the request time point.

28. The system of claim 27, wherein the processing status of the first service request at the target time point includes executing a matching process based on the first service request and the one or more candidate service requests, or determining the target service provider.

29. The system of claim 28, wherein the at least one processor is further directed to cause the system to:
provide a first option and a second option to the first service requester via the user interface, wherein the first option indicates that the first service requester agrees with a delay of executing the matching process, and the second option indicates that the first service provider agrees with executing, in real time, the matching process; and
receive a first input associated with the first option or a second input associated with the second option from the first service requester.

30. The system of claim 29, wherein the first option includes a set of predetermined time points, and the first input includes selecting a predetermined time point from the set of predetermined time points as the target time point.

31. (canceled)

32. The system of claim 27, wherein the target time point is determined based on a waiting time period of the first service requester and the request time point, and wherein
the waiting time period is a time period that the first service requester is willing to wait from the request time point to the target time point, and
the waiting time period is estimated based on reference information.

33. The system of claim 32, wherein the reference information includes at least one of the start location, a weather condition, a traffic condition, preference information of the first service requester, one or more historical service requests of the first service requester, or one or more historical service requests of other service requesters.

34. The system of claim 27, wherein the target time point is determined from a set of predetermined time points.

35-44. (canceled)
